(19) United States
(12) Patent Application Publication
(10) Pub. No.: US 2020/0104398 A1
(43) Pub. Date: Apr. 2, 2020

(54) UNIFIED MANAGEMENT OF TARGETING ATTRIBUTES IN A/B TESTS

(71) Applicant: Microsoft Technology Licensing, LLC, Redmond, WA (US)

(72) Inventors: Alexander Ivaniuk, Sunnyvale, CA (US); Jingbang Liu, Cupertino, CA (US); Shaochen Huang, San Francisco, CA (US); Jiahui Qi, Mountain View, CA (US); Shaohua Xie, Santa Clara, CA (US)

(73) Assignee: Microsoft Technology Licensing, LLC, Redmond, WA (US)

(21) Appl. No.: 16/146,603

(22) Filed: Sep. 28, 2018

(51) Int. Cl. G06F 17/30; G06F 9/48; G06Q 30/02; G06F 11/07

(52) U.S. Cl. CPC G06F 17/30469; G06F 9/4812; G06F 11/0757; G06F 17/30489; G06Q 30/0201; G06F 17/30864

(57) ABSTRACT

The disclosed embodiments provide a system for performing unified management of targeting attributes in A/B tests. During operation, the system obtains attribute configurations for attributes to be used in subsequent targeting of users by A/B tests. Next, the system configures, based on the attribute configurations, onboarding of the attributes from an offline environment, a near-real-time environment, and an online environment. During an A/B test, the system retrieves values of one or more of the attributes for a user from locations specified in the attribute configurations. Finally, the system outputs the values with targeting conditions for the A/B test for use in selecting a treatment assignment for the user in the A/B test.

### BACKGROUND

### Field

The disclosed embodiments relate to A/B testing. More specifically, the disclosed embodiments relate to techniques for performing unified management of targeting attributes in A/B tests.

### Related Art

A/B testing, or controlled experimentation, is a standard way to evaluate user engagement or satisfaction with a new service, feature, or product. For example, a company may use an A/B test to show two versions of a web page, email, article, social media post, layout, design, and/or other information or content to users to determine if one version has a higher conversion rate than the other. If results from the A/B test show that a new treatment version performs better than an old control version by a certain amount, the test results may be considered statistically significant, and the new version may be used in subsequent communications or interactions with users already exposed to the treatment version and/or additional users.

A/B testing techniques commonly involve defining segments of users to target with A/B tests, as well as subsequent assignment of users in each segment to the treatment and control versions. For example, a segment of users may be defined based on demographic attributes such as location, language, age, education, profession, occupation, and/or income level; behavioral attributes such as views, user sessions, level of engagement, searches, and/or features used; and/or platform-specific attributes such as operating system, application type (e.g., mobile, native, web, etc.), and/or application version. The segment may also include a distribution of treatment assignments in a corresponding A/B test (e.g., 50% treatment and 50% control, 10% treatment and 90% control, 100% treatment, etc.). In turn, the segment may be defined to include certain users and/or exclude certain users, as well as control the exposure of the users to the treatment version of an A/B test.

Consequently, fine-grained and/or intelligent segmentation of users in A/B tests may improve the accuracy, performance, and/or flexibility of A/B testing techniques.

### BRIEF DESCRIPTION OF THE FIGURES

FIG. 1 shows a schematic of a system in accordance with the disclosed embodiments.

FIG. 2 shows a system for performing unified management of targeting attributes in A/B tests in accordance with the disclosed embodiments.

FIG. 3 shows a flowchart illustrating a process of performing unified management of targeting attributes in A/B tests in accordance with the disclosed embodiments.

FIG. 4 shows a flowchart illustrating a process of retrieving attribute values for a user for use in targeting the user with an A/B test in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing A/B testing. During an A/B test, one set of users may be assigned to a treatment group that is exposed to a treatment variant, and another set of users may be assigned to a control group that is exposed to a control variant. The users' responses to the exposed variants may then be monitored and used to determine if the treatment variant performs better than the control variant.

More specifically, the disclosed embodiments provide a method, apparatus, and system for performing unified management of targeting attributes in A/B tests. The targeting attributes may include user attributes, platform attributes, and/or custom attributes that are used to define segments of users to be included in the A/B tests, as well as to perform subsequent assignment of the users to treatment and control groups in the A/B tests. For example, an A/B test may include one or more segments of users, with each segment defined to include or exclude users based on attributes such as the users' countries, languages, locales, industries, operating systems, application types (e.g., mobile, native, web, etc.), and/or application versions. Each segment may further specify a distribution of treatment assignments in the A/B test, such as 50% treatment and 50% control, 10% treatment and 90% control, and/or 100% treatment.

To manage the targeting attributes in a unified and/or centralized fashion, attribute configurations for the attributes may be obtained and used to onboard the attributes from multiple environments. For example, an attribute configuration may include a name, description, attribute type, entity type (e.g., users, companies, jobs, and/or other entities represented by an attribute), owner, data source, environment, and/or other metadata that can be used to define and/or retrieve values of the corresponding attribute. The attribute configuration may be stored in a centralized repository and/or another data store to register the attribute with a centralized A/B testing platform. The attribute configuration may further be used to retrieve the attribute's values from an offline, near-real-time, and/or real-time environment, validate the retrieved values, and/or aggregate the values into one or more repositories for the corresponding environment(s). The onboarding process may further be standardized per environment. For example, offline attributes may be stored in a centralized data store, near-real-time attributes may be emitted through one or more event streams in a distributed streaming platform, and real-time attributes may be requested from a common interface.

After the attributes are onboarded, the attributes may be used to resolve treatment assignments of users to A/B tests. For example, a set of attributes may be identified in targeting conditions that define one or more segments of users in an A/B test. Attribute configurations for the attributes may be used to retrieve the attributes from the corresponding repositories and/or environments, and the targeting conditions may be applied to the attributes to identify segments to which the users belong. The users may then be assigned to treatment and control groups of the A/B test according to distributions of treatment assignments for the corresponding segments.

By managing the registration, onboarding, and retrieval of targeting attributes from multiple locations and/or environments in a centralized manner, the disclosed embodiments may reduce the complexity and/or overhead associated with defining, managing, and/or using the attributes. The disclosed embodiments may further allow different teams and/or entities to share and/or reuse attributes without requiring the entities to understand how the attributes are generated and/or where the attributes are located. Consequently, the disclosed embodiments may provide technological improvements related to the development and use of computer systems, applications, services, and/or workflows for defining, identifying, producing, and/or consuming targeting attributes used in A/B tests.

### Unified Management of Targeting Attributes in A/B Tests

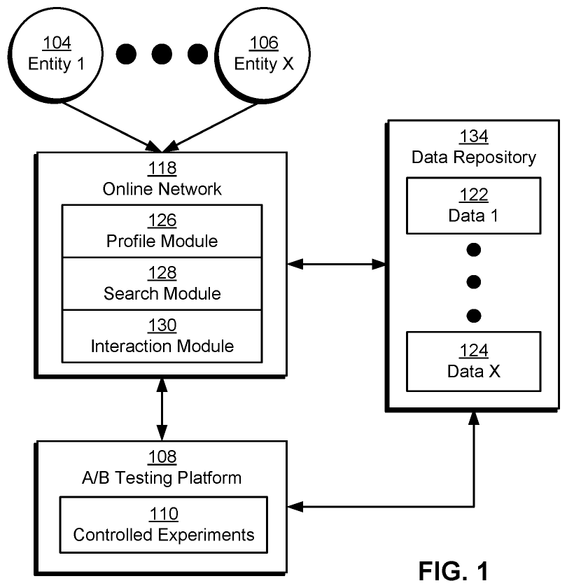

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, data in data repository 134 may be used by an A/B testing platform 108 to conduct controlled experiments 110 of features in online network 118. Controlled experiments 110 may include A/B tests that expose a subset of the entities to a treatment variant of a message, feature, and/or content. For example, A/B testing platform 108 may select a random percentage of users for exposure to a new treatment variant of an email, social media post, feature, offer, user flow, article, advertisement, layout, design, and/or other content during an A/B test. Other users in online network 118 may be exposed to an older control variant of the content.

During an A/B test, entities affected by the A/B test may be exposed to the treatment or control variant, and the entities' responses to or interactions with the exposed variants may be monitored. For example, entities in the treatment group may be shown the treatment variant of a feature after logging into online network 118, and entities in the control group may be shown the control variant of the feature after logging into online network 118. Responses to the control or treatment variants may be collected as clicks, views, searches, user sessions, conversions, purchases, comments, new connections, likes, shares, and/or other performance metrics representing implicit or explicit feedback from the entities. The metrics may be aggregated into data repository 134 and/or another data-storage mechanism on a real-time or near-real-time basis and used by A/B testing platform 108 to compare the performance of the treatment and control variants.

In one or more embodiments, A/B testing platform 108 includes functionality to perform unified management of targeting attributes that are used to assign users to treatment and/or control variants of controlled experiments 110. Such unified management may include the centralized registration, onboarding, retrieval, and use of attributes from multiple environments such as offline environments, near-real-time environments, and/or real-time environments.

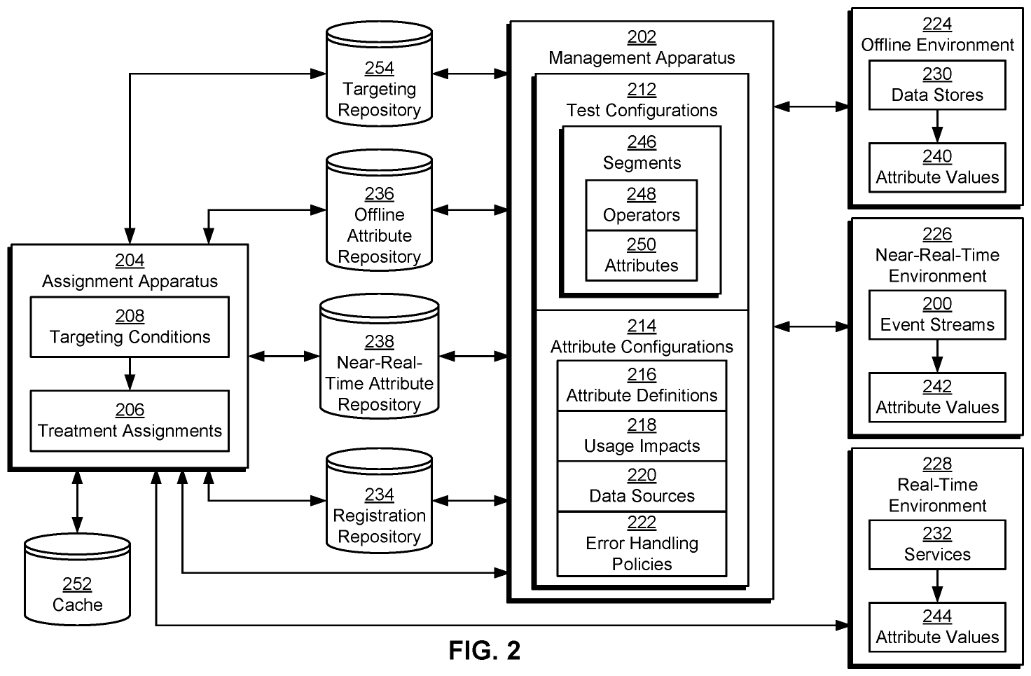

As shown in FIG. 2, a system for performing unified management of targeting attributes 250 in A/B tests (e.g., A/B testing platform 108 of FIG. 1) includes a management apparatus 202 and an assignment apparatus 204. Each of these components is described in further detail below.

Management apparatus 202 handles the definition, registration, and/or onboarding of data used to perform A/B tests. In turn, assignment apparatus 204 uses the data to generate treatment assignments 206 of users in the A/B tests.

First, management apparatus 202 obtains test configurations 212 that are used to set up A/B tests in the A/B testing platform. For example, management apparatus 202 may provide a user interface that allows a user to specify and/or select parameters of a test configuration. In another example, management apparatus 202 may obtain a test configuration that is defined using a domain-specific language (DSL) associated with the A/B testing platform.

Test configurations 212 may include criteria for targeting users with the corresponding A/B tests. Each test configuration may specify one or more segments 246 of users for inclusion in a corresponding A/B test. In addition, each segment may be defined to include or exclude attributes 250 of the corresponding users.

For example, attributes 250 may include user profile attributes such as a whitelist of user IDs and/or the users' names, registration dates, graduation years, locations, industries, positions, companies, schools, languages, occupations, and/or account types (e.g., free, paid, premium, etc.). Attributes 250 may also indicate the presence or absence of profile pictures, summaries, endorsements, and/or other fields in the users' profiles (e.g., with an online network and/or website). In another example, attributes 250 may include platform-specific attributes, such as the operating systems, application types (e.g., mobile, web, native, etc.), application names, application versions, devices, network connection types (e.g., cellular, wired, wireless, etc.), and/or other characteristics of hardware and/or software used by the users to access or use the treatment and/or control variants in the A/B test. In a third example, attributes 250 may include usage attributes such as metrics related to the users' number of sessions, duration of sessions, clicks, views, posts, likes, searches, connection requests, messages, and/or other types of activity with an online network and/or website on which the A/B test is run. In a fourth example, attributes 250 may include custom attributes that are defined and onboarded using user-specified attribute configurations 214, as described in further detail below.

Each segment may also include one or more operators 248 that are used to evaluate the corresponding attributes 250. Operators 248 may include logical operators (e.g., and, or, xor, xnor, not, etc.), comparison operators (e.g., equals, does not equal, greater than, less than, greater than or equal to, less than or equal to, etc.), and/or inclusion operators (e.g., includes, excludes, etc.). Together, operators 248 and attributes 250 may form targeting conditions 208 that are subsequently used by assignment apparatus 204 to identify a segment to which a user belongs in an A/B test.

Test configurations 212 may further specify distributions of treatment assignments 206 within segments 246 of each A/B test. For example, a test configuration may specify that users in a segment be assigned to the treatment and control groups of an A/B test according to a 50/50 split between treatment and control. In another example, a test configuration may indicate assignment of 10% of users in a segment to the treatment group and assignment of 90% of users in the same segment to the control group. In a third example, a test configuration may specify a “default” assignment of 100% of users that cannot be placed into other segments of an A/B test to the control group of the A/B test.

An example test configuration may include the following representation:
(ab(=(country-code) (value “us”))[treatment 50]
(lt(connection-count) (value 100)) [treatment 20]
(all)[control 100])
   The representation includes a first targeting condition that applies an equality operator to an attribute named “country-code” and a value of “us.” The representation specifies that 50% of users that belong to the segment represented by the first targeting condition (i.e., users with a “country-code” attribute value that equals “us”) should be assigned to the treatment group of an A/B test. In turn, the remaining 50% of users may be assigned to the control group of the same A/B test.

The representation also includes a second targeting condition that applies a “less than” comparison operator to an attribute named “connection-count” and a value of 100. The representation indicates that 20% of users that belong to the segment represented by the second targeting condition (i.e., users with a “connection-count” attribute value that is less than 100) should be assigned to the treatment group of the A/B test.

Finally, the representation includes a default segment of “all” that is applied to all users that do not belong to the other two segments in the test configuration (e.g., users with “country-code” attribute values that do not equal “us” and with “connection-count” attribute values that are not less than 100). The representation specifies that 100% of users that belong in the default segment be assigned to the control group of the A/B test.

After test configurations 212 are obtained from and/or provided by users, management apparatus 202 stores test configurations 212 in a targeting repository 254. Assignment apparatus 204 and/or other components of the system may subsequently retrieve test configurations 212 from targeting repository 254 and use the retrieved test configurations 212 to generate treatment assignments 206 for the users in the corresponding A/B tests.

Second, management apparatus 202 obtains attribute configurations 214 that define attributes 250 that can be used to target users with A/B tests. As with test configurations 212, attribute configurations 214 may be provided by users through a user interface, DSL, and/or other mechanism for interacting or communicating with management apparatus 202.

Attribute configurations 214 include attribute definitions 216, usage impacts 218, data sources 220, and error handling policies 222. Attribute definitions 216 contain metadata that is used to describe and/or subsequently validate the corresponding attributes 250. For example, an attribute definition for an attribute may include a name (e.g., “country-code”), description, attribute type (e.g., string, Boolean, number, long, double, date, version, string collection, number collection, etc.), entity type (e.g., users, companies, contracts, and/or other entities described by the attribute), and/or owner (e.g., a user or team that is responsible for generating the attribute).

Usage impacts 218 include current or anticipated usage of the corresponding attributes 250 within or across one or more organizations. For example, an attribute configuration may specify an attribute's usage impact as a “tier” of 0, 1, or 2. A tier of 0 may indicate that the attribute will be used by and/or impact all teams in an organization, a tier of 1 may indicate that the attribute will be used by and/or impact multiple teams in the organization, and a tier of 2 may indicate that the attribute will be used by only one team in the organization.

Data sources 220 may identify environments, data stores, services, tools, and/or other mechanisms for accessing attribute values 240-244 of attributes 250. As mentioned above, the environments may include an offline environment 224, a near-real-time environment 226, and/or a real-time environment 228. In general, environments from which attributes 250 may be obtained may represent different execution contexts, groups of hardware and/or software resources, and/or latencies associated with producing or updating attribute values 240-244 of attributes 250.

Offline environment 224 may include data stores 230 that are updated with attribute values 240 on a periodic and/or batch processing basis. For example, offline environment 224 may include a distributed data store such as Hadoop Distributed File System (HDFS) that stores attribute values 240 that are generated on an hourly and/or daily basis. As a result, data sources 220 associated with attributes 250 from offline environment 224 may include paths and/or locations of offline data stores 230 and/or identify tools or workflows that are used to load attribute values 240 into data stores 230.

Near-real-time environment 226 may include event streams 200 that transmit records of recently created and/or updated attribute values 242. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to the data from a source of truth for the data. Data sources 220 associated with attributes 250 from near-real-time-environment 226 may thus include Kafka topics representing event streams 200 that publish recent changes to attribute values 242.

Real-time environment 228 may include services 232 that process queries for attribute values 244 in real-time. For example, services 232 may include Representational State Transfer (REST) services and/or other types of services that return the latest attribute values 244 in response to requests for the corresponding attributes 250. In turn, data sources 220 in real-time environment 228 may include service names, service endpoints, and/or service calls for retrieving attribute values 244.

Error handling policies 222 may be used to handle errors or failures in retrieving attributes 250 from the corresponding environments. For example, error handling policies 222 may specify timeouts and/or retries associated with failures in retrieving the corresponding attributes 250. In another example, error handling policies 222 may specify targeting of users in A/B tests using cached values of attributes 250, default values of attributes 250, and/or default targeting conditions for the A/B tests when attributes 250 cannot be retrieved from the corresponding environments and/or one or more repositories (e.g., offline attribute repository 236, near-real-time attribute repository 238, etc.) into which attributes 250 are aggregated.

After attribute configurations 214 for one or more attributes are received, management apparatus 202 carries out an onboarding process for each attribute based on the environment from which the attribute is obtained. First, management apparatus 202 may register attributes 250 in a registration repository 234 and/or with assignment apparatus 204 based on usage impacts 218. For example, management apparatus 202 may register attributes 250 with wide usage impacts 218 (e.g., usage across multiple teams and/or by all teams in an organization) with registration repository 234 by storing attribute definitions 216, usage impacts 218, data sources 220, and/or policies for the attributes in registration repository 234. In turn, users from different teams may retrieve the registered attributes 250 from registration repository 234 for subsequent use and/or reuse with targeting conditions 208 of the users' A/B tests. In another example, management apparatus 202 and/or users from which attribute configurations 214 were obtained may register attributes 250 directly with one or more instances of assignment apparatus 204 when the attributes have narrow usage impacts 218 (e.g., usage by only one team and/or a few teams).

Next, management apparatus 202 may aggregate attribute values 240 from offline environment 224 into offline attribute repository 236. For example, management apparatus 202 may execute one or more data-processing pipelines that consume data sets containing attribute values 240 from data stores 230 in offline environment 224, aggregate attribute values 240 by entity keys (e.g., user IDs, company IDs, contract IDs, etc.) for the entity types in the corresponding attribute configurations 214, and store the aggregated attribute values 240 in offline attribute repository 236.

Similarly, management apparatus 202 may aggregate attribute values 242 from near-real-time environment 226 into near-real-time repository 238. For example, management apparatus 202 may consume events from event streams 200, perform deduplication of records containing the same attribute values 242 and entity keys from event streams 202, and aggregate attribute value 242 by the entity keys into near-real-time attribute repository 238.

Prior to storing attribute values 240-242 in offline attribute repository 236 and near-real-time attribute repository 238, management apparatus 202 may validate attribute values 240-242. For example, management apparatus 202 may verify that each set of attribute values 240-242 conforms to a schema, is not used with multiple redundant attributes 250, and/or meets predefined data quality standards.

Consequently, management apparatus 202 may populate targeting repository 254, offline attribute repository 236, near-real-time attribute repository 238, and/or registration repository 234 with data that is used to execute A/B tests. In turn, assignment apparatus 204 may use the data to target users with the A/B tests.

More specifically, assignment apparatus 204 obtains targeting conditions 208 for one or more segments 246 of an A/B test from targeting repository 254 and/or management apparatus 202. Assignment apparatus 204 matches attributes 250 in targeting conditions 208 to the corresponding attribute configurations 214 in registration repository 234 (e.g., when attributes 250 are registered in registration repository 234) and/or a local data store (e.g., when attributes 250 are registered locally on assignment apparatus 204).

Assignment apparatus 204 then uses data sources 220 in attribute configurations 214 to identify environments from which attributes 250 are obtained. If an attribute is from offline environment 224, assignment apparatus 204 may retrieve attribute values 240 of the attribute from offline attribute repository 236. If an attribute is from near-real-time environment 226, assignment apparatus 204 may retrieve attribute values 242 of the attribute from near-real-time attribute repository 238. Offline attribute repository 236 and near-real-time attribute repository 238 may thus allow assignment apparatus 204 to retrieve attribute values 240-242 from offline environment 224 and near-real-time environment 226 without making multiple calls to different data stores 230, subscribing to multiple event streams 220, and/or performing subsequent aggregation of attribute values 240-242.

If an attribute is from real-time environment 228, assignment apparatus 204 may call a service (e.g., services 232) identified in the attribute configuration for the attribute to retrieve attribute values 244 of the attribute. Assignment apparatus 204 may also validate attribute values 244 and/or other data returned by the service prior to using attribute values 244. As a result, attribute values 244 from real-time environment 228 may represent the latest values of the attribute instead of values that are weakly consistent with the corresponding sources of truth, such as attribute values 240-242 in offline attribute repository 236 and/or near-real-time attribute repository 238.

For example, the service may implement the following interface to enable retrieval of attribute values 244 on a real-time basis:

```
public interface Attribute<T> {
  String getEntityType( );
  AttributeType getAttributeType( );
  String getAttributeName( );
  Task<T> getFetchAttributeValueTask(Urn urn);
}
```

In the above interface, the “getEntityType( )” method is used to retrieve an entity type (e.g., user, company, contract, etc.) associated with an attribute. The “getAttributeType( )” method is used to retrieve an attribute type (e.g., string, Boolean, double, long, string collection, long collection, date, test version, etc.) associated with the attribute. The “getAttributeName( )” method is used to retrieve the name of the attribute. Finally, the “getFetchAttributeValueTask( )” method is used to retrieve the attribute value corresponding to a Uniform Resource Number (URN) such as an entity key.

Assignment apparatus 204 may call the “getEntityType( ),” “getAttributeType( ),” and “getAttributeName( )” methods to retrieve an attribute definition for the attribute. Next, assignment apparatus 204 may use the attribute definition to verify that the attribute name matches a corresponding attribute name in targeting conditions 208 and the entity type of the attribute is valid (e.g., the entity type of the attribute matches the entity type associated with targeting conditions 208). Assignment apparatus 204 may similarly verify that the attribute type of the attribute is compatible with targeting conditions 208 (e.g., the attribute type can be used with one or more corresponding operators 248 in targeting conditions 208). Assignment apparatus 204 may then call the “getFetchAttributeValueTask( )” method to retrieve the latest value of the attribute from the service.

Assignment apparatus 204 may further batch calls and/or requests to retrieve attribute values 240-244 from offline attribute repository 236, near-real-time attribute repository 238, and/or real-time environment 228. For example, assignment apparatus 204 may retrieve multiple attribute values for the same attribute from a given data source (e.g., offline attribute repository 236, near-real-time attribute repository 238, and/or real-time environment 228) for use in subsequent targeting of a set of users in an A/B test.

After attribute values have been retrieved for some or all targeting conditions 208, assignment apparatus 204 applies targeting conditions 208 to the retrieved attribute values to generate treatment assignments 206 for one or more users in an A/B test. For example, assignment apparatus 204 may apply targeting conditions 208 for segments 246 in an A/B test in the order in which segments 246 are declared in the test configuration for the A/B test. In turn, assignment apparatus 204 may assign the user to the first segment in which the user's attribute values evaluate to true using the corresponding targeting conditions 208. Assignment apparatus 204 may then select a treatment assignment for the user based on the distribution of treatment assignments 206 for the corresponding segment.

Assignment apparatus 204 may further store recently retrieved attribute values in a local cache 252 to expedite subsequent processing of targeting conditions 208 for the same entities. For example, assignment apparatus 204 may maintain attribute values in cache 252 based on a time-to-live (TTL) of 15 minutes to reduce the number of subsequent remote calls to offline attribute repository 236, near-real-time attribute repository 238, and/or services 232.

On the other hand, assignment apparatus 204 may experience an error and/or failure during retrieval of an attribute value from offline attribute repository 236, near-real-time attribute repository 238, and/or services 232. As a result, assignment apparatus 204 may use the error handling policy (e.g., error handling policies 222) for the corresponding attribute to retry a request for the attribute value, retrieve the attribute value from cache 252, obtain a default value of the corresponding attribute, and/or use a default targeting condition and/or default segment for the A/B test.

By managing the registration, onboarding, and retrieval of targeting attributes from multiple locations and/or environments in a centralized manner, the system of FIG. 2 may reduce complexity and/or overhead associated with defining, managing, and/or using the attributes. The system may further allow different teams and/or entities to share and/or reuse attributes without requiring the entities to understand how the attributes are generated and/or where the attributes are located. Consequently, the disclosed embodiments may provide technological improvements related to the development and use of computer systems, applications, services, and/or workflows for defining, identifying, producing, and/or consuming targeting attributes used in A/B tests.

Those skilled in the art will appreciate that the system of FIG. 2 may be implemented in a variety of ways. First, management apparatus 202, assignment apparatus 204, registration repository 234, offline attribute repository 236, near-real-time attribute repository 238, targeting repository 254, and/or cache 252 may be provided by a single physical machine, multiple computer systems, one or more virtual machines, a grid, one or more databases, one or more filesystems, and/or a cloud computing system. Management apparatus 202 and assignment apparatus 204 may additionally be implemented together and/or separately by one or more hardware and/or software components and/or layers.

Second, test configurations 212, attribute configurations 214, attribute values 240-244, and/or other data used by the system may be obtained from and/or persisted in a number of data sources. As mentioned above, the data sources may include data stores 230 in offline environment 224, event streams 200 in near-real-time environment 226, and services 232 in real-time environment 228. In turn, data from the data sources may be stored in repositories such as HDFS, Structured Query Language (SQL) databases, key-value stores, and/or other types of data stores. One or more repositories (e.g., registration repository 234, offline attribute repository 236, near-real-time attribute repository 238, targeting repository 254, etc.) may further be replicated, merged, and/or omitted to accommodate requirements or limitations associated with the processing, performance, scalability, and/or redundancy of the system.

Third, the system may be adapted to various types of experiments and/or hypothesis tests. For example, the system of FIG. 2 may be used to assign users to different groups and/or cohorts in A/B tests, studies, and/or other types of research designs for different features and/or versions of websites, social networks, applications, platforms, advertisements, recommendations, and/or other hardware or software components that impact user experiences.

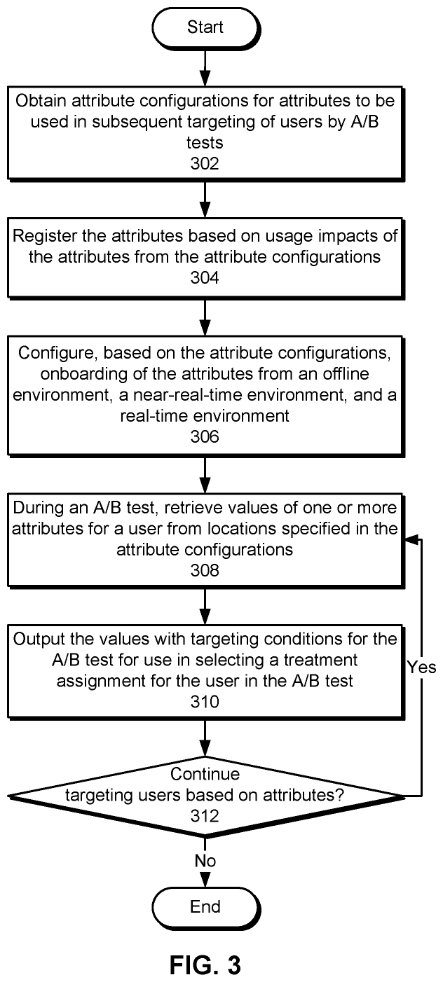

FIG. 3 shows a flowchart illustrating a process of performing unified management of targeting attributes in A/B tests in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, attribute configurations for attributes to be used in subsequent targeting of users by A/B test are obtained (operation 302). For example, a user may provide the attribute configurations through a user interface and/or using a DSL associated with user targeting in A/B tests. The attribute configurations may include fields such as an attribute name, an attribute type, a description, an entity type, an owner, a data source, and/or an error handling policy.

Next, the attributes are registered based on usage impacts of the attributes from the attribute configurations (operation 304). For example, each attribute may be assigned a “tier” indicating the extent of the attribute's use within an organization. If the tier represents use of the attribute by multiple teams and/or all teams in the organization, the attribute may be registered in a centralized repository to allow the attribute to be discovered by the teams. If the tier represents use of the attribute by only one team in the organization, the attribute may be registered directly with a component that uses the attribute to perform targeting of users for the team's A/B tests.

Onboarding of the attributes from an offline environment, a near-real-time environment, and a real-time environment is then configured based on the attribute configurations (operation 306). For example, the attributes may be located in an offline data store based on data sources specified in the attribute configurations, aggregated by entity keys associated with the attributes, and stored in a repository associated with the offline environment. In another example, one or more event streams specified in the attribute configurations may be used to obtain records of recent changes to the attributes, and values of the attributes may be aggregated from the event streams into a repository associated with the near-real-time environment. In a third example, one or more methods of an interface with a real-time service may be called to obtain an attribute definition containing an attribute type, entity type, and/or attribute name of an attribute, and the attribute may be validated based on the attribute definition.

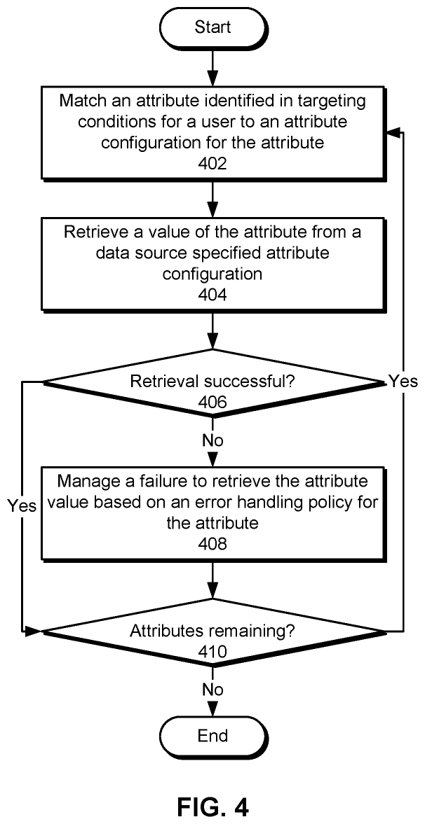

During an A/B test, values of one or more attributes for a user are retrieved from locations specified in the attribute configurations (operation 308), as described in further detail below with respect to FIG. 4. Finally, the values are outputted with targeting conditions for the A/B test for use in selecting a treatment assignment for the user in the A/B test (operation 310). For example, the values and targeting conditions may be transmitted to an “engine” that evaluates the values based on the targeting conditions and identifies a segment to which the user belongs. The engine may then select a treatment assignment for the user based on a distribution of treatment assignments for the segment.

Targeting of users based on attributes may continue (operation 312). For example, attributes of the users may continue to be used to target the users in A/B tests while the A/B tests are running During each A/B test, values of attributes for a user are retrieved from locations specified in the attribute configurations (operation 308), and the values are outputted with targeting conditions for the A/B test to select a corresponding treatment assignment for the user (operation 310). Operations 308-312 may be repeated until treatment assignments are generated for all users in all A/B tests.

FIG. 4 shows a flowchart illustrating a process of retrieving attribute values for a user for use in targeting the user with an A/B test in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, an attribute identified in targeting conditions for a user is matched to an attribute configuration for the attribute (operation 402). For example, the name of the attribute may be obtained from the targeting conditions and used to retrieve the attribute configuration for the attribute. Next, a value of the attribute for the user may be retrieved from a data source specified in the attribute configuration (operation 404). For example, the value of the attribute may be retrieved from a repository storing aggregated attribute values from an offline and/or near-real-time environment. In another example, the value of the attribute may be obtained by calling one or more services in a real-time environment.

The attribute is then processed based on a success or failure of the retrieval (operation 406). If the retrieval is successful, the attribute's value may be used to evaluate one or more corresponding targeting conditions for the user, as discussed above.

If the retrieval is unsuccessful, the failure to retrieve the value of the attribute is managed based on an error handling policy for the attribute (operation 408). For example, the error handling policy may be obtained from the attribute configuration for the attribute and/or a general error handling policy for the data source of the attribute. The error handling policy may specify a timeout, a number of retries, a cached value of the attribute, a default value of the attribute, and/or a default targeting condition for the A/B test.

Operations 402-408 may be repeated for remaining attributes (operation 410) for the user. For example, operations 402-408 may be used to retrieve some or all attribute values required to evaluate one or more targeting conditions for the user. The attribute values may then be combined with operators (e.g., logical operators, comparison operators, inclusion operators, etc.) in the targeting conditions to generate true/false evaluation results for the targeting conditions. In turn, the user may be assigned to the first segment for which the evaluation result is true, and the user may be assigned to a treatment or control group in the A/B test based on a distribution of treatment assignments associated with the segment.

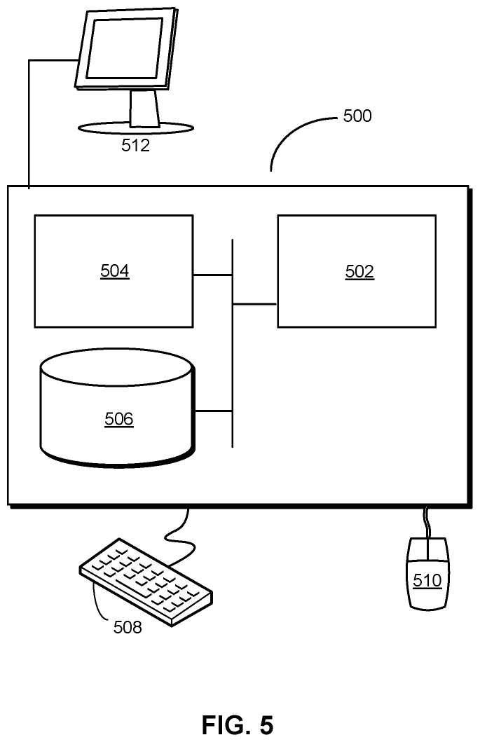

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the disclosed embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing unified management of targeting attributes in A/B tests. The system includes a management apparatus and an assignment apparatus, one or more of which may alternatively be termed or implemented as a module, mechanism, or other type of system component. The management apparatus obtains attribute configurations for attributes to be used in subsequent targeting of users by A/B tests. Next, the management apparatus uses the attribute configurations to configure onboarding of the attributes from an offline environment, a near-real-time environment, and an online environment. During an A/B test, the assignment apparatus retrieves values of one or more of the attributes for a user from locations specified in the attribute configurations. Finally, the assignment apparatus outputs the values with targeting conditions for the A/B test for use in selecting a treatment assignment for the user in the A/B test.

In addition, one or more components of computer system 500 may be remotely located and connected to the other components over a network. Portions of the present embodiments (e g, management apparatus, assignment apparatus, data repository, targeting repository, registration repository, offline attribute repository, near-real-time attribute repository, online network, etc.) may also be located on different nodes of a distributed system that implements the embodiments. For example, the present embodiments may be implemented using a cloud computing system that manages the registration, onboarding, and retrieval of attributes in a set of remote environments.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining attribute configurations for attributes to be used in subsequent targeting of users by A/B tests;
configuring, by one or more computer systems based on the attribute configurations, onboarding of the attributes from an offline environment, a near-real-time environment, and an online environment;
during an A/B test, retrieving values of one or more of the attributes for a user from locations specified in the attribute configurations; and
outputting the values with targeting conditions for the A/B test for use in selecting a treatment assignment for the user in the A/B test.

2. The method of claim 1, wherein configuring onboarding of the attributes from the offline environment comprises:
locating the attributes, based on the attribute configurations, in an offline data store;
aggregating the attributes from the offline data store by entity keys associated with the attributes; and
storing the aggregated attributes in a repository associated with the offline environment.

3. The method of claim 1, wherein configuring onboarding of the attributes from the near-real-time environment comprises:
subscribing to one or more event streams specified in the attribute configurations; and
aggregating the attributes from the one or more event streams into a repository associated with the near-real-time environment.

4. The method of claim 1, wherein configuring onboarding of the attributes from the real-time environment comprises:
calling an interface with a service to obtain an attribute definition for an attribute; and
validating the attribute based on the attribute definition.

5. The method of claim 1, further comprising:
registering the attributes based on usage impacts of the attributes from the attribute configurations.

6. The method of claim 5, wherein registering the attributes based on usage impacts of the attributes comprises:
storing an attribute configuration of an attribute in a centralized repository when the attribute configuration comprises a wide usage of the attribute across an organization.

7. The method of claim 1, wherein retrieving the values of the one or more attributes for the user comprises:
matching an attribute identified in the targeting conditions to an attribute configuration for the attribute; and
retrieving a value of the attribute for the user from a data source specified in the attribute configuration.

8. The method of claim 7, wherein retrieving the values of the one or more attributes for the user from the one or more data sources further comprises:
managing a failure to retrieve another value of another attribute for the user from another data source based on an error handling policy for the other attribute.

9. The method of claim 8, wherein the error handling policy comprises at least one of:
a timeout;
a number of retries;
a cached value of the other attribute;
a default value of the other attribute; and
a default targeting condition for the A/B test.

10. The method of claim 1, wherein the targeting conditions comprise:
the one or more of the attributes; and
one or more operators to be applied to the one or more of the attributes.

11. The method of claim 10, wherein the one or more operators comprise at least one of:
a logical operator;
a comparison operator; and
an inclusion operator.

12. The method of claim 1, wherein the attribute configurations comprise at least one of:
an attribute name;
an attribute type;
a description;
an entity type;
an owner; and
a data source.

13. A system, comprising:
one or more processors; and
memory storing instructions that, when executed by the one or more processors, cause the system to:
obtain attribute configurations for attributes to be used in subsequent targeting of users by A/B tests;
configure, based on the attribute configurations, onboarding of the attributes from an offline environment, a near-real-time environment, and an online environment;
during an A/B test, retrieve values of one or more of the attributes for a user from locations specified in the attribute configurations; and
output the values with targeting conditions for the A/B test for use in selecting a treatment assignment for the user in the A/B test.

14. The system of claim 13, wherein configuring onboarding of the attributes from the offline environment comprises:
locating the attributes, based on the attribute configurations, in an offline data store;
aggregating the attributes from the offline data store by entity keys associated with the attributes; and
storing the aggregated attributes in a repository associated with the offline environment.

15. The system of claim 13, wherein configuring onboarding of the attributes from the near-real-time environment comprises:
subscribing to one or more event streams specified in the attribute configurations; and
aggregating the attributes from the one or more event streams into a repository associated with the near-real-time environment.

16. The system of claim 13, wherein configuring onboarding of the attributes from the real-time environment comprises:
calling an interface with a service to obtain an attribute definition for an attribute; and
validating the attribute based on the attribute definition.

17. The system of claim 13, wherein the memory further stores storing instructions that, when executed by the one or more processors, cause the system to:
register the attributes based on usage impacts of the attributes from the attribute configurations.

18. The system of claim 13, wherein retrieving the values of the one or more attributes for the user comprises:
matching an attribute identified in the targeting conditions to an attribute configuration for the attribute;
retrieving a value of the attribute for the user from a data source specified in the attribute configuration; and
managing a failure to retrieve another value of another attribute for the user from another data source based on an error handling policy for the other attribute.

19. The system of claim 18, wherein the error handling policy comprises at least one of:
a timeout;
a number of retries;
a cached value of the other attribute;
a default value of the other attribute; and
a default targeting condition for the A/B test.

20. A non-transitory computer-readable storage medium storing instructions that when executed by a computer cause the computer to perform a method, the method comprising:
obtaining attribute configurations for attributes to be used in subsequent targeting of users by A/B tests;
configuring, based on the attribute configurations, onboarding of the attributes from an offline environment, a near-real-time environment, and an online environment;
during an A/B test, retrieving values of one or more of the attributes for a user from locations specified in the attribute configurations; and
outputting the values with targeting conditions for the A/B test for use in selecting a treatment assignment for the user in the A/B test.
